(19) United States
(12) Patent Application Publication
(10) Pub. No.: US 2014/0048202 A1
(43) Pub. Date: Feb. 20, 2014

(54) SPIRAL CUT LIQUID ADHESIVE LAMINATED FILM

(71) Applicants: V. Pethaperumal, Pondichery (IN); S. Ganeshkumar, Pondichery (IN); G. Kalaiselvi, Pondichery (IN)

(72) Inventors: V. Pethaperumal, Pondichery (IN); S. Ganeshkumar, Pondichery (IN); G. Kalaiselvi, Pondichery (IN)

(21) Appl. No.: 14/003,810

(22) PCT Filed: Mar. 1, 2012
(86) PCT No.: PCT/IN12/00146

§ 371 Date: Sep. 9, 2013

(30) Foreign Application Priority Data
Mar. 9, 2011 (IN) 697/CHE/2011

(51) Int. Cl. B32B 38/18; B32B 37/12; B32B 38/00

(52) U.S. Cl. CPC B32B 38/18; B32B 38/0004; B32B 37/1284
USPC 156/255; 156/555; 156/512; 156/499

(57) ABSTRACT

The present invention relates to laminate of films for applications in which relatively high yield strength and ultimate tensile strength is required. In one embodiment this is accomplished by drawing tube (106) from a storage means onto a tube roller and cutting the tube length into two film, a first film and a second film, where the first and second film are in opposite angular direction with respect to the roller rotation, coating the first film with liquid adhesive composition by passing between at least two film guiders, where one of the guider is dipped in liquid adhesive tray (110), in which said composition includes resin and hardener and laminating the second film with the coated liquid adhesive first film by passing them together through at least two film guiders (112) under pressure to produce a spiral cut liquid adhesive laminated film.

### FIELD OF THE INVENTION

The present invention relates to laminate of films for applications in which relatively high yield strength and ultimate tensile strength is required, a method and apparatus thereof. Examples of such applications are: tarpaulins, pondliners, substitute of geotextiles, weather protective laminates, greenhouse film, industrial bags, carrier bags, self-standing pouches etc.

### BACKGROUND OF THE INVENTION

A laminate is a material that can be constructed by uniting two or more layers material together. The process of creating a laminate is lamination, which in common parlance refers to the placing of layers of plastic one over the other with an adhesive layer in between them and gluing them together with heat and/or pressure.

The materials used in laminates can be same or of different type. An example of the type of laminate using different materials would be the application of a layer of plastic film—the “laminate”—on either side of a sheet of glass—the laminated subject.

A sandwich structured composite is a special class of composite materials that is fabricated by attaching two thin but stiff skins to a lightweight but thick core. The core material is normally low strength material, but its higher thickness provides the sandwich composite with high bending stiffness with overall low density.

Open and closed cell structured foams like polyvinylchloride, polyurethane, polyethylene or polystyrene foams, balsa wood, syntactic foams and honeycombs are commonly used core materials,

The core is bonded to the skins with an adhesive. The strength of the composite material is largely dependent on two factors:

The outer skins: If the sandwich is supported on both sides, and then stressed by means of a force in the middle of the beam, then the bending moment will introduce shear forces in the material. The shear forces results in the bottom skin being in tension and the top skin being in compression. The core material spaces these two skins apart. The thicker core material, the stronger the composite. This principle works in much the same way as an I-beam does.

The interface between the core and the skin: Because the shear stresses in the composite material changes rapidly between the core and the skin, the adhesive layer also sees some degree of shear force. If the adhesive bond between the two layers is too weak, the most probable result will be delamination.

Prior art focuses on different types of laminated films which are designed to be used as packaging or covering materials in various walks of life. Few examples of such laminated films are provided below herein.

One such process for preparation of laminated film is disclosed in U.S. Pat. No. 4,908,253 granted to Rasmussen and Ole-bendt. It discloses the manufacture of a laminate comprising weakly adhered biaxially oriented film, with fibrous morphology. The laminate is produced by melt attenuating the blends and strongly biaxially orienting the laminate by stretching in several steps. In another aspect, the invention uses thermoplastic components, which are heated during melt attenuation. Thus the process requires greater energy and causes distortion of the layers during heating process.

U.S. Pat. No. 6,284,344 granted to Barnes and Christopher C. E. teaches the formation of multi-layer bias-cut films. The multi-layer bias-cut films are produced from several layers of monoaxially oriented thermoplastic film that have been bias cut at different bias angles to change the machine direction angle in the film. Another aspect of the invention uses two or three layers of bias-cut film, where at least two layers have different machine direction angles. The invention uses thermoplastic for cross lamination, which means that it is comparatively bulky and may tend to distort the properties of the laminated layers.

U.S. Publication No. 20090317650 to Yang et al, talks of cross-laminated films consisting of thermoplastic and elastic components, to be used for wrapping, sealing and bagging. In one aspect the invention comprises of co-extrusion of the laminated films wherein the films are of thermoplastic. Since the sealing ply is also made of thermoplastic material, it involves laborious and costly methods of sealing and lamination.

In light of the above mentioned prior arts, the invention already exists on the manufacture of cross-laminated films for packaging and bagging uses thermoplastic as their sealing component and use heat and pressure for sealing. Thermoplastic being heavy adds to the bulk of the product and also gets distorted while being subjected to heat and pressure. This may affect the quality of the end product like evenness, strength, elasticity, durability and shear capacity. These components and processes add to cost as well making the end product uneconomical and less competitive in the commercial market.

Thus, there is a need for a product which uses such components, so as to retain the original properties of the laminates, and is also economical. The elimination of steps like subjecting the laminates to heat and pressure may reduce the overall cost, as the energy spent in doing so can be saved. Also, there is need for a product with such sealing component which seals and sets at ambient conditions, so that the unevenness or rigidity of the laminates caused due to heating can be avoided.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one aspect of the present invention is a method of producing a laminated film, the method comprising: drawing tube from a storage means onto a tube roller and cutting the tube length into two film, a first film and a second film, where the first and second film are in opposite angular direction with respect to the roller rotation, coating the first film with liquid adhesive composition by passing between at least two film guiders, where one of the guider is dipped in liquid adhesive tray, the liquid adhesive composition includes resin and hardener and laminating the second film with the coated liquid adhesive first film by passing them together through at least two film guiders under pressure to produce a spiral cut liquid adhesive laminated film.

In another aspect of the present invention is an arrangement for producing a laminated film, the arrangement comprising: a first and a second roller having a first film and a second film, wherein the first and second film are in opposite angular direction with respect to their roller rotation, a liquid adhesive composition tray is arranged with first roller for coating the first film, wherein the coating is done by passing the film between at least two film guider, where one of the guider is dipped in liquid adhesive tray, the liquid adhesive composition includes resin and hardener and means for laminating the second film with the coated liquid adhesive first film by passing them together through at least two film guiders under pressure to produce a spiral cut liquid adhesive laminated film.

### BRIEF DESCRIPTION OF THE INVENTION

The accompanying drawings, which are incorporated in and constitute a part of this specification, illustrate various implementations of the invention and, together with the description, serve to explain the advantages and principles of the invention. In the drawings:

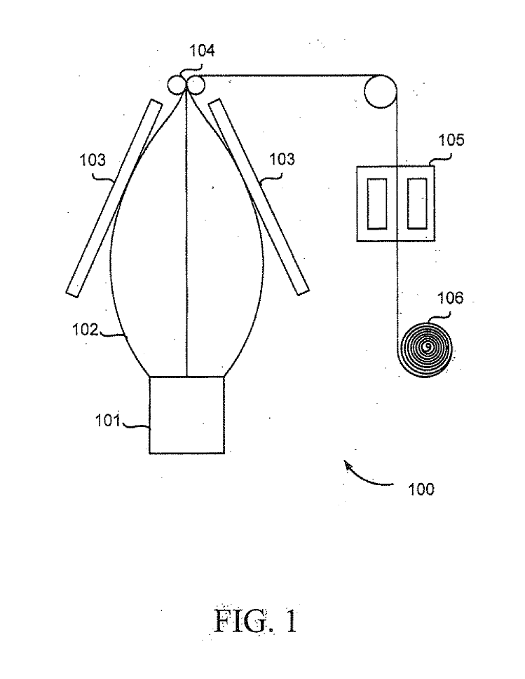

FIG. 1 shows the multiply extrusion of the flattened tube made of a polymer.

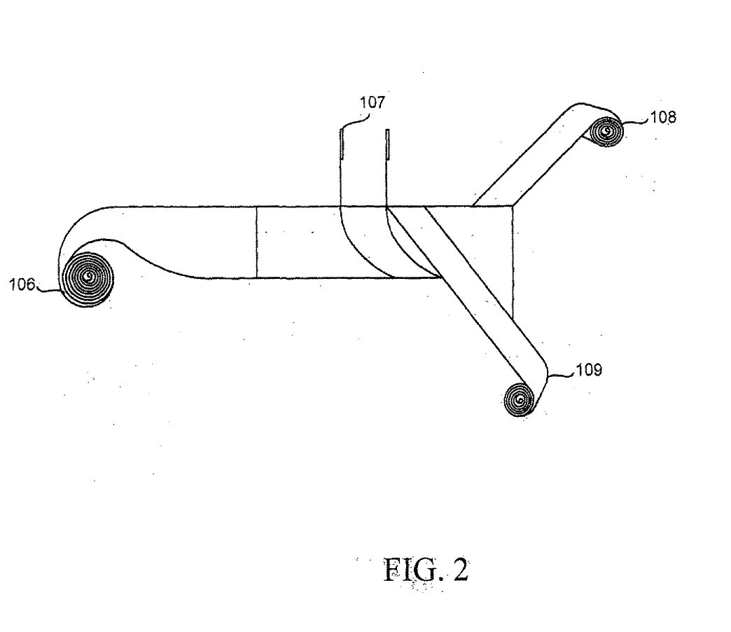

FIG. 2 shows the spiral cutting of the co-extruded flattened tube in two opposite angular directions with respect to roller rotation.

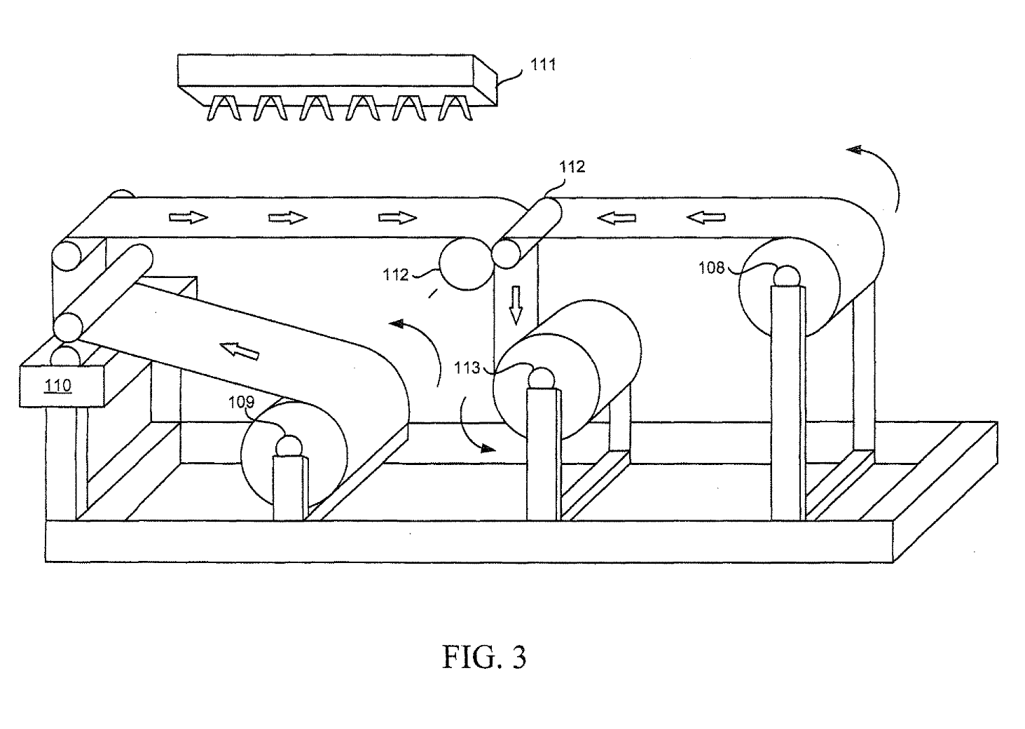

FIG. 3 shows lamination of one of the spiral cut roll with liquid adhesive by dipping it in liquid adhesive tray.

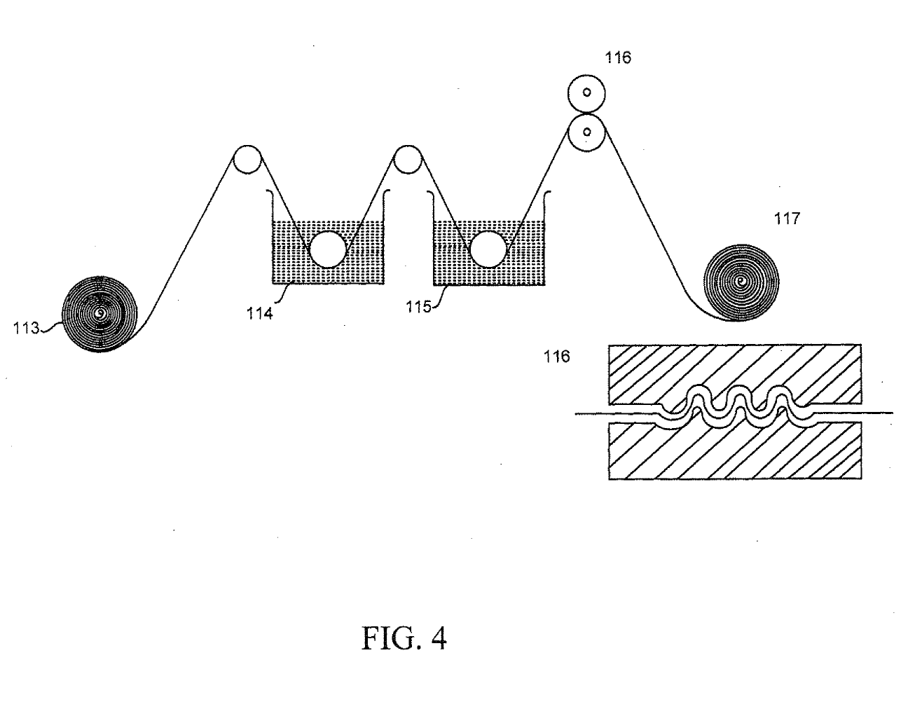

FIG. 4 shows stretching and annealing of the spiral cut, liquid adhesive laminated film.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure.

Throughout the drawings, it should be noted that like reference numbers are used to depict the same or similar elements, features, and structures.

### DETAIL DESCRIPTION OF THE INVENTION

The following detailed description of the invention refers to the accompanying drawings. Wherever possible, the same reference numbers will be used throughout the drawings and the following description to refer to the same and like parts. Dimensions of certain parts shown in the drawings may have been modified and/or exaggerated for the purposes of clarity or illustration.

The present invention reveals a method of producing a spiral cut liquid adhesive laminated film. FIG. 1 shows a polymer based layer in the form of flattened tube 106, consisting of a minimum of three multilayer plies. The manufacture of flattened tube involves extrusion process 101, ballooning 102, squeezing 103, nipping 104 and corona treatment 105. This process can be adopted/used for monolayer also.

The flattened tube 201 is loaded onto a roller as shown in FIG. 2 and is spiral cut in two opposite angular directions with respect to roller rotation using at least one knife (preferably two knives 202) and these films are wound into two rolls 203 and 204.

One film 302 is coated with liquid adhesive (consisting of resin and hardener) as in FIG. 3, by passing the film between roils or film guiders (of which one roll is dipped in liquid adhesive tray 303). The liquid adhesive is a solvent based two component adhesive system comprising of a polyurethane and polyisocyanade additive. They are known in the market as high performance adhesive systems CAC 2511/CAC 1511A. The liquid adhesive coated film is dried by means of Hot Air Blowers 304. After this operation, the other film 301 is laminated by passing the films together through rollers 305 under pressure. Thus the spiral cut liquid adhesive laminated film is born 306. In this method of lamination/sealing there is no thermoplastic or elastic component thus substantially reducing the weight of the finished product.

Thus the spiral cut laminated/liquid adhesive film is kept in the rolls for 24 hours for “curing” of the adhesive mixture.

Now the spiral cut laminated/liquid adhesive film 401, undergoes “annealing operation” by stretching the film in Machine Direction (MD) 403 by immersing in hot water/air bath 402 and chilled water bath in 404. Subsequently the film undergoes stretching in Transverse Direction (TD) by passing the film through a set of grooved rollers 405. Thus the description discloses a process and method spiral cutting and an apparatus which will perform the spiral cutting and a laminate produced by spiral cutting process employing liquid adhesive.

Now the cross laminated/liquid adhesive film undergoes “trimming operation” along the edges to ensure uniform width between 1-1.5 m.

For larger widths, beyond 1-1.5 m, more than two, the cross laminated/sealed film will be stitched longitudinally using hot sealing process.

For specific applications where wrapping/typing of cross laminated film is required, plastic/metallic eyelets are fixed along the edges of the film after folding, using ultrasonic welding/mechanical clamping devices as the case may be. This film will also be useful for other applications such as large size bags involving Form, Fill, seal packing.

By undergoing the above mentioned method, the tensile strength of the spiral cut liquid adhesive laminated film is in the range of 290-230 Kgf/cm² in machine direction and traverse direction. More particularly, the tensile strength of the spiral cut liquid adhesive laminated film along the machine direction is 291.93 Kgf/cm² and along the transverse direction is 231.42 Kgf/cm².

The elongation of the spiral cut liquid adhesive laminated film is 850% along machine direction and 975% along the transverse direction. The tear resistance of the spiral cut liquid adhesive laminated film along the machine direction 2799 gmf and transverse direction 4814 gmf.

A recent test for the product from the above mentioned process was exposed and is as follows:

| | | | | Result |
|---|---|---|---|---|
| S. No. | Property | Standard | Unit | Obtained |
| 1. | Thickness | — | Micron | 134 |
| 2. | Ultimate Tensile Strength | ASTM | | |
| | (a) Machine Direction | D-882 | Kgf/cm² | 291.93 |
| | (b) Transverse Direction | | | 231.42 |
| | Elongation at break | | | |
| | (a) Machine Direction | | % | 853.88 |
| | (b) Transverse Direction | | | 972.78 |
| 3. | Dart Impact Strength | IS 2508 | gm | 245 |
| | (Height 66 cm) | | | |
| 4. | Tear Strength | ASTM | | |
| | (a) Machine Direction | D-1922 | gmf | 2798.3 |
| | (b) Transverse Direction | | | 4815.23 |
| 5. | GSM | — | g/m² | 192 |

### ADVANTAGES OF THE INVENTION

The packing and covering materials come with various components and properties. This invention focuses on a cross-laminated film with spiral cut and liquid adhesive used as the sealing material.

The spiral cutting of the film increases its shear strength, weight bearing capacity and high barrier strength. Cross-lamination increases flexibility and life of the film, which also makes it tear resistant, puncture resistant and all-weather resistant.

Using liquid adhesive for sealing the two polymer layers decreases the cost and weight. As this particular invention does not require heat or pressure for its gluing process, it not only prevents distortion of the sandwiched layers but also reduces the cost of production, thus making the product competitive in the market.

This film is more economical, more durable and ensures evenness of the surface, owing to use of liquid adhesive for sealing the plies as against a thermoplastic used in the prior art. Hence, the invention has many advantages over existing methods of preparation of laminated films.

The film thus produced also has other desirable qualities like water proof, shrink proof, rot proof and chemical resistance. It is pliable or flexible, which makes it easy to fold. The film is easy to clean and handle. Since the film has stitch less joints and hemmed edges, it is attractive too. The spiral cut film is UV resistant too which makes it more preferable to be used in hot sun.

The film thus produced is without disturbing the actual process and also without collapsing the original material.

The cost of Plant and Machinery vis-a-vis Capital Investment is more compared to the cost of P & M in our process; also the cost of Thermoplastic sealing material is high compared to the cost of liquid sealing material. Both these factors will contribute to the reduction of selling price of the end product.

The inventive concept disclosed in present description contemplates the following:
1. The use of a liquid adhesive polyurethane and polyisocyanate. These adhesives were hitherto not used in art. Instead, heat sealing and thermoplastics were in use.
2. The process of manufacturing a laminated film by spiral cutting.
3. The apparatus for manufacturing laminated film by spiral cutting of the different layers.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the summary of the invention, except where the context requires otherwise due to express language or necessary implication, the word “comprising” is used in the sense of “including”, i.e. the features specified may be associated with further features in various embodiments of the invention.

We claim:

1. A method of producing a laminated film, the method comprising:
drawing tube from a storage means onto a tube roller and cutting the tube length into two film, a first film and a second film, where the first film and second film are in opposite angular direction with respect to the roller rotation;
coating the first film with liquid adhesive composition by passing between at least two film guiders, where one of the guider is dipped in liquid adhesive tray, the liquid adhesive composition includes resin and hardener; and
laminating the second film with the coated liquid adhesive first film by passing them together through at least two film guiders under pressure to produce a spiral cut liquid adhesive laminated film.

2. The method of claim 1, wherein the step of laminating excludes thermoplastic or elastic components thereby substantially reducing the weight of the film.

3. The method of claim 1, further comprising:
drying the liquid adhesive coated film with the help of a hot air blower, wherein the hot air blower is placed between the liquid adhesive composition tray and the laminating means.

4. The method of claim 1, further comprising:
curing the laminated adhesive film with applied heat and pressure during passage through the nip.

5. The method of claim 1, further comprising:
annealing the laminated adhesive film by stretching the film in machine direction by immersing in hot water/air bath and chilled water bath in transverse direction by passing the film through a set of grooved film guiders.

6. The method of claim 1, further comprising:
trimming the laminated adhesive film along the edges for uniform width.

7. An arrangement for producing a laminated film, the arrangement comprising:
a first and a second roller having a first film and a second film, wherein the first and second film are in opposite angular direction with respect to their roller rotation;
a liquid adhesive composition tray is arranged with first roller for coating the first film, wherein the coating is done by passing the film between at least two film guider, where one of the guider is dipped in liquid adhesive tray, the liquid adhesive composition includes resin and hardener; and
means for laminating the second film with the coated liquid adhesive first film by passing them together through at least two film guiders under pressure to produce a spiral cut liquid adhesive laminated film.

8. The arrangement for producing a laminated film of claim 7, further comprising:
a storage means to draw the tube from a tube roller and cutting the tube length into two film, wherein the first film is on the first roller and the second film is on the second roller.

9. The arrangement for producing a laminated film of claim 7, wherein the spiral cut laminated liquid adhesive laminated film having characteristics of high barrier, water proof, shrink proof, rot proof, tear resistant, weather resistant, puncture resistant, chemical resistant, UV stabilized, light in weight, flexible, handle and hemmed at edges.

10. The arrangement for producing a laminated film of claim 7, further comprising:
a hot air blower placed between the liquid adhesive composition tray and the lamination means, wherein the hot air blower is for drying the liquid adhesive coated film.
